(19) United States
(12) Patent Application Publication
(10) Pub. No.: US 2009/0260919 A1
(43) Pub. Date: Oct. 22, 2009

(54) SAFETY LINE ANCHOR

(75) Inventors: Richard Alan Frederick Beale, Wiltshire (GB); Timothy George Bissett, Wiltshire (GB); Karl Jones, Wiltshire (GB)

Correspondence Address: FULWIDER PATTON LLP, HOWARD HUGHES CENTER, 6060 CENTER DRIVE, TENTH FLOOR, LOS ANGELES, CA, 90045, US

(73) Assignee: LATCHWAYS PLC., Devizes, Wiltshire (GB)

(21) Appl. No.: 11/914,277

(22) PCT Filed: Apr. 25, 2005
(86) PCT No.: PCT/GB06/01491

§ 371 Date: Jun. 12, 2008

(30) Foreign Application Priority Data
May 30, 2006 (GB) 0509852.0

(51) Int. Cl. E04G 21/32; A62B 1/04; A62B 35/00

(52) U.S. Cl. 182/3

(57) ABSTRACT

An anchor assembly for an elongate safety line comprises safety line gripping means connected to a bracket means by a releasable clamping means. The releasable clamping means comprises a tapered clamp formed by first and second opposed clamping surfaces defining a tapered space between them, a tapered member having a tapered profile matching the tapered space and a clamping element adapted to urge the first and second clamping surfaces together to clamp the tapered member between them.

The present invention relates to height safety equipment and, in particular, to an anchoring arrangement suitable for anchoring the lower end of an installation of a flexible elongate safety line disposed in a substantially vertical orientation on a tall structure.

Tall structures such as electricity pylons and radio or satellite communication masts are periodically inspected to determine whether any maintenance work is required. These structures are purposely built to be low maintenance and, because many of them stand in remote locations, they may require inspection only once every ten years, perhaps longer. Also, in the interests of public safety, such structures are constructed to discourage easy ascent by non-authorised personnel. Hence, the lower leg portions of metal towers of this type are usually plain metal to a height of at least three metres from ground level, with no foot- or hand-holds. In fact, if such structures were built with access-ways or the like, the access-ways themselves would require periodic inspection for compliance with safety regulations. The interval between routine safety inspections is shorter than the required interval between routine maintenance inspections, so it would significantly increase the frequency of inspection for any kind of permanent access-way to form part of the tall structure.

Traditionally, personnel who have carried out maintenance inspections on metal towers, pylons, or the like have used rope-access techniques for ascent and making themselves fast at the top. In an effort to minimise some of the hazards associated with such work, the present applicants have devised fall arrest systems that can be installed on a tall structure. The above-mentioned fall arrest systems include new bottom anchor assemblies for securing a substantially vertically-oriented safety line to the lower portion of a tall structure which are described in European patent number EP 1054708B and International Patent Publication number WO2005/000407A.

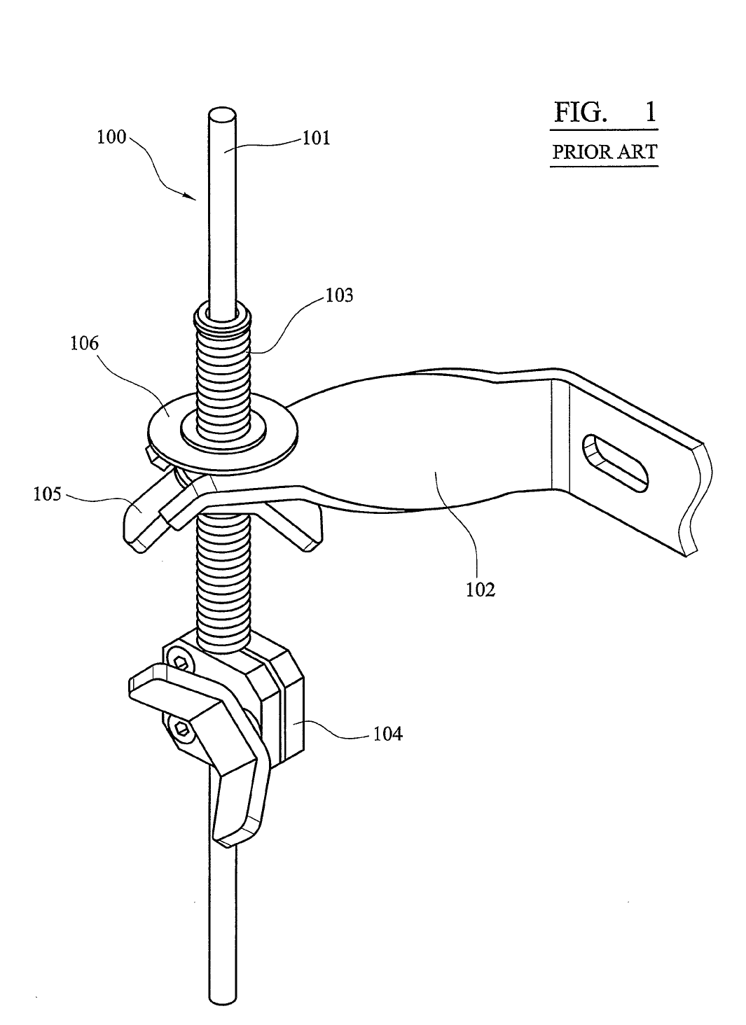

One example of a known bottom anchor assembly according to EP1054708B. is shown in FIG. 1. The bottom anchor assembly 100 secures the lower end of a safety line 101 and tensions the safety line 101. The bottom anchor assembly 100 is attached to the tall structure (not shown) through a bracket 102. The bottom anchor assembly 100 includes an externally screw threaded hollow shaft 103 through which the safety line 101 passes. A clamp 104 attached to the lower end of the shaft 103 clamps the safety line 101 and prevents it moving relative to the shaft 103. A nut 105 engaged with the externally screw threaded shaft 103 bears against the lower surface of the bracket 102 so that the safety line 101 can be tensioned to a desired level by rotating the nut 105 to move the shaft 103 upwardly or downwardly relative to the bracket 102 and a tension indicator 106 is provided to allow the tension to be set to the correct value.

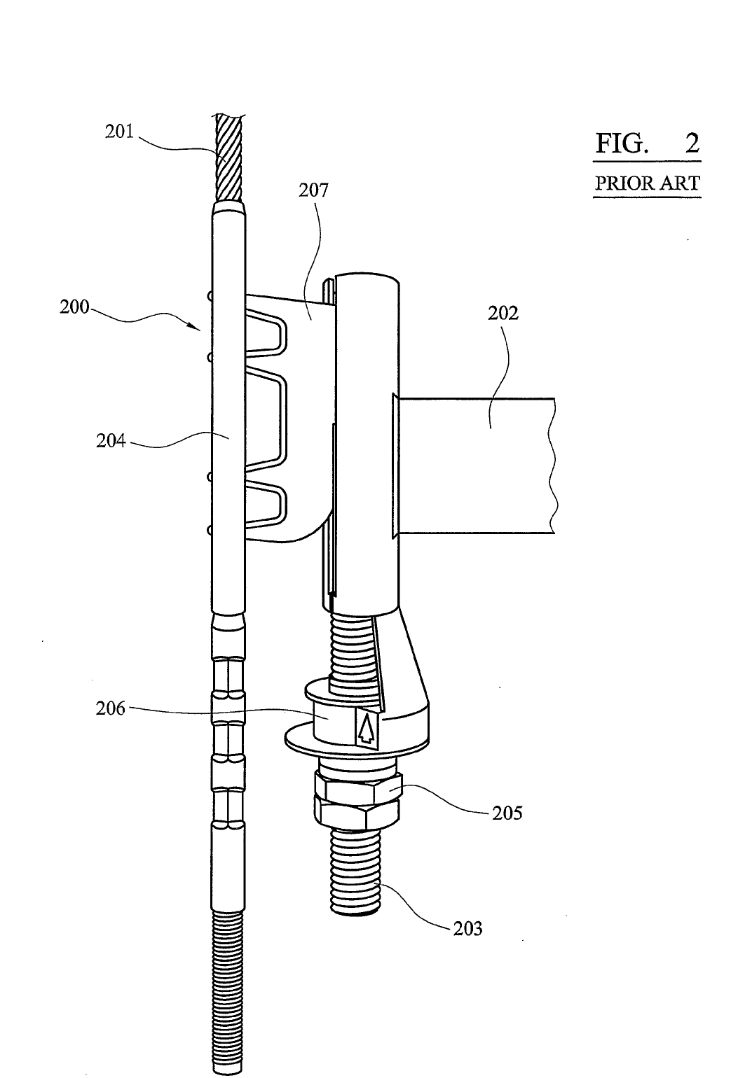

Another example of a known bottom anchor assembly according to WO2005/000407A is shown in FIG. 2. The bottom anchor assembly 200 secures the lower end of safety line 201 and tensions the safety line 201. The bottom anchor 200 is attached to the tall structure (not shown) through a bracket 202. The bottom anchor assembly 200 includes an externally screw threaded shaft 203. A clamp 204 is attached to the shaft 203 by support arm 207. The clamp 204 clamps the safety line 201 and prevents it moving relevant to the shaft 203. A nut 205 engaged with the externally screw threaded shaft 203 bears against the lowest surface of the bracket 202 and a tension indicator 206 is provided, so that the safety line 201 can be tensioned to a desired level by rotating the nut 205 to move the shaft 203 relative to the bracket 202.

This bottom anchor assembly operates similarly to the bottom anchor assembly of FIG. 1 except that the safety line clamp 204 is separated from the tensioning assembly by a support arm 207 instead of being integral with the tensioning assembly by use of a hollow shaft. The use of a support arm 206 allows safety line travellers moving along the safety line 201 in either direction to traverse the bottom anchor assembly 200.

Although these safety line bottom anchor arrangements have proved highly successful, some disadvantages have been encountered in use.

The bottom anchor assemblies including the tensioning means and a tension indicator to allow the safety line to be set to the required tension are bulky, heavy and relatively costly items. It is generally desirable to reduce the bulk, weight and cost of height safety equipment in order to encourage more widespread use.

Further, as explained above, the bottom anchors are intended for use as bottom anchors for height safety systems which are temporally installed while a tall structure is undergoing periodic inspection and are then removed for use on another structure. The requirement that the safety line anchor be transported between locations for successive installation, use and removal makes the bulk and weight of the safety line anchor a greater problem than in fixed systems.

Finally, as noted above tall structures of the type which the safety line anchors are generally used with are commonly designed to present a plain smooth metal service providing no foot or hand holds to a height of at least three metres from ground level. As a result, the bracket used to attach the safety line bottom anchor must be located three metres or more above ground level in order to prevent it being used as a hand or foot hold to climb the structure. This location of the bracket at least three metres from the ground is also advantageous to prevent in accidental or malicious damage to the bracket and other parts of the fall arrest system. The location of the bracket three metres or more above ground level makes bulk and weight of the bottom anchor assembly particularly disadvantageous because of the requirement to lift and secure the assembly at height. This is a particular problem because, as explained above, many tall structures of this type stand in remote locations so that it is inconvenient and expensive if installation and removal of the safety line anchor requires personnel or lifting equipment in addition to the inspection team itself.

The present invention was made in order to overcome these problems, at least in part.

In a first aspect, this invention provides an anchor assembly for an elongate safety line, the anchor assembly comprising safety line gripping means bracket means and a releasable clamping means connecting the gripping means and the bracket means, in which the releasable clamping means comprises a tapered clamp formed by first and second opposed clamping surfaces defining a tapered space between them, a tapered member having a tapered profile matching the tapered space and a clamping element adapted to urge the first and second clamping surfaces together to clamp the tapered member between them.

When tension is applied to an elongate safety line by the anchor assembly the tapered clamp prevents slippage or creep of the safety line relative to the bracket means and so allows a desired tension to be reliably applied to the safety line without it being necessary to include tension applying or sensing means in the anchor assembly. Accordingly, the bulk, weight and cost of the anchor assembly can all be reduced and installation at height made easier.

Preferred embodiments of the invention will now be described, by way of example only, with reference to the accompanying diagrammatic figures, in which:

FIG. 1 shows a perspective view of a first known safety line bottom anchor;

FIG. 2 shows a perspective view of a second known safety line bottom anchor;

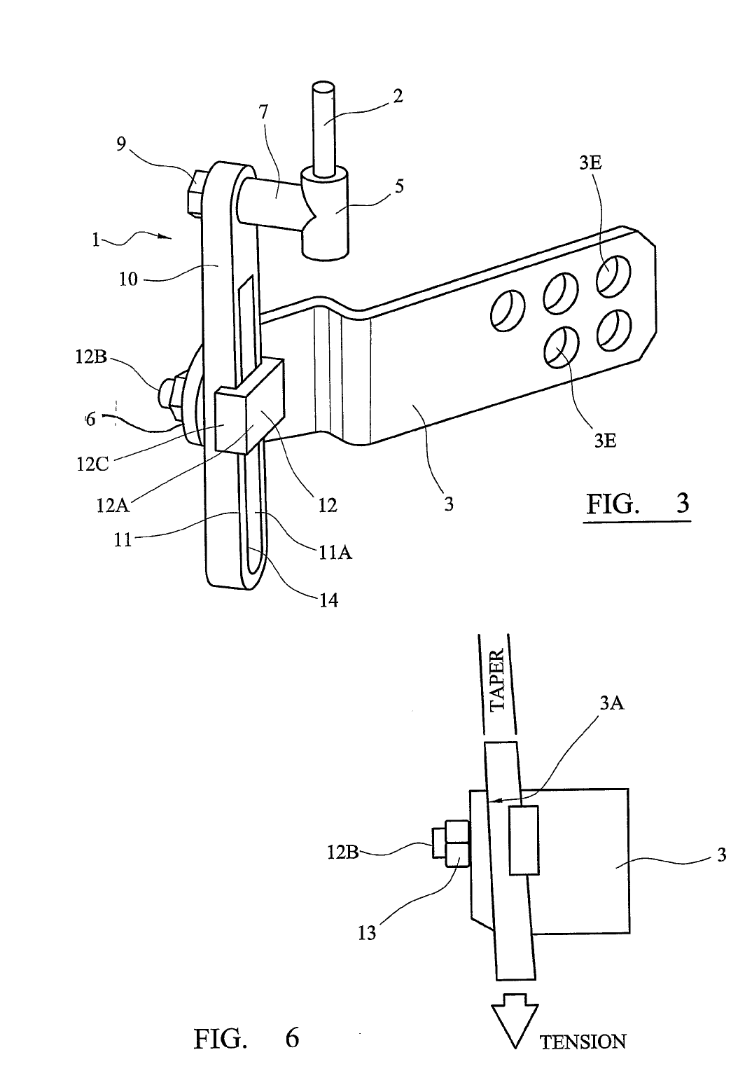

FIG. 3 shows a perspective view of a safety line bottom anchor according to a first embodiment of the present invention;

FIG. 4 shows a top plan view of the bottom anchor of FIG. 3 with the safety line released;

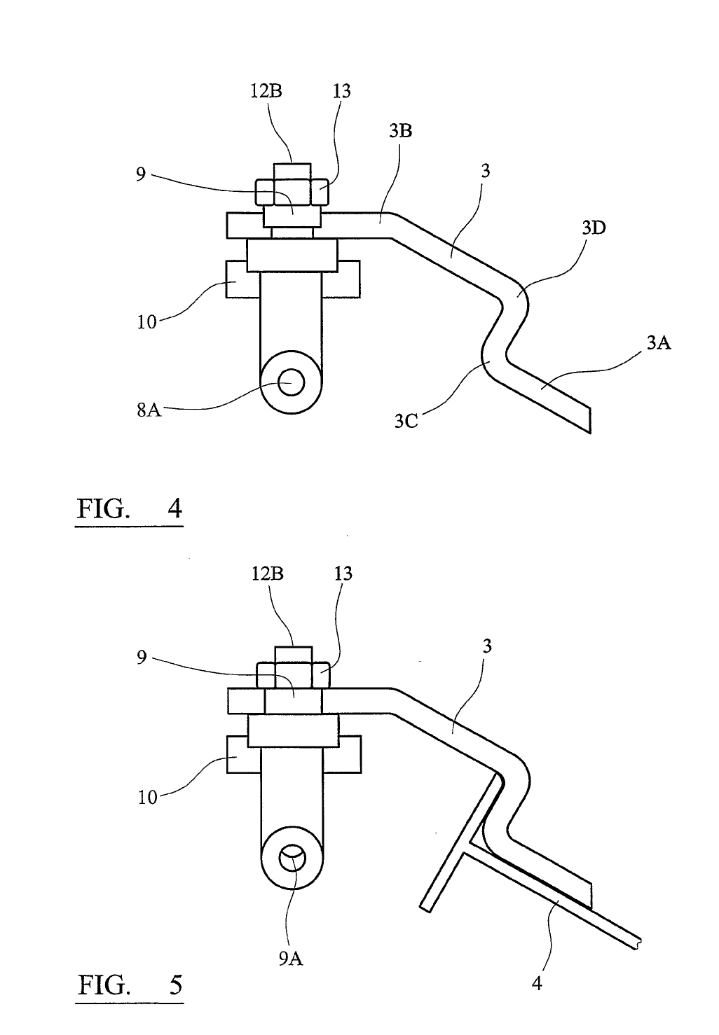

FIG. 5 shows a top plan view of the bottom anchor of FIG. 3 with the safety line secured; and

FIG. 6 shows a side view of the clamping section of the bottom anchor of FIG. 3.

A bottom anchor assembly 1 according to a first embodiment of the invention is shown in FIGS. 3 to 6. In FIG. 3 the bottom anchor assembly 1 is shown as part of a fall arrest system attached to a safety line 2 in the form of a multi stranded metal cable. The bottom anchor assembly 1 comprises a cable securing section 5 and a clamping section 6 linked by a support arm 7, and a bracket 3 adapted to secure the bottom anchor assembly 1 to a fixed structure 4. For clarity, the fixed structure 4 is not shown in FIG. 3 so that the bracket 3 can be seen. The fixed structure is shown in cross section in FIG. 5.

Typically the fixed structure 4 will be a tall structure such as an electricity pylon or radio or satellite communication mast. However, the invention is applicable to any structure requiring protection for workers or other personnel with a height safety or fall arrest system.

The cable securing section 5 comprises a hollow cylindrical tube 8 having a central bore 8a through which the safety line 2 passes. A securing bolt 9 is arranged to engage with the safety line 2 and hold it in place within the tube 8 by an end 9a of the securing bolt 9 passing into the bore 8a and compressing the safety line 2 against the side of the bore 8a. The securing bolt 9 is able to move between a first release position shown in FIG. 4, in which the end 9a of the securing bolt 9 does not extend into the bore 8a and a second securing position, shown in FIG. 5, in which the end 9a of the securing bolt 9 does extend into the bore 8a.

The use of a tube 8 with a bore 8a through which the safety line 2 passes has several advantages. This arrangement allows installation and tensioning of the safety line without the safety line needing to be cut to a required length, because any excess safety line can simply hang below the anchor. In practice the safety line will usually be stored on a drum and the required amount payed, the excess length of safety line simply being left on the drum on the ground below the anchor. This allows the same safety line to be used and re-used as part of a temporary fall arrest system at a number of different locations in turn. Further, in situations where the bottom anchor assembly 1 is itself located at height having a continuous length of safety line 2 extending both above and below the bottom anchor assembly 1 conveniently allows the untensioned safety line 2 hanging below the bottom anchor assembly 1 to be used as a guide or fall arrest system for personnel climbing up to or down from the bottom anchor assembly 1. In this situation it will be understood that the bottom anchor assembly is the bottom anchor of the tensioned safety line 2, although not at the bottom of the entire system.

The separation of the cable securing section 5 from the clamping section 6 by the support arm 7 allows safety line travellers moving along the safety line 2 in either direction to traverse the bottom anchor assembly 1.

In order to allow the action of the securing bolt 9 to be seen, the safety line 2 is not shown in FIGS. 4 and 5.

The clamping section 6 comprises an elongate member 10 attached to the support arm section 7 at a first, upper, end and having an engagement aperture 14 at a second, lower, end. The elongate member 10 has a tapered central section 11 located between its first and second ends. A wedge clamp arrangement is formed by the tapered section 11 and a clamp member 12. The tapered section 11 passes between a surface 3a of the bracket 3 and a clamping surface 12a of the clamping member 12 opposed to the surface 3a.

The clamping member 12 is connected to the bracket 3 by an externally threaded shaft 12b passing through an elongate slot 11a in the tapered section 11 of the elongate member 10 and an aperture (not shown) in the bracket 3. A clamp nut 13 is provided engaging the screw threaded surface of the shaft 12b so that the tapered section 11 can be releasably clamped between the clamp member 12 and the bracket 3 by tightening or loosening the clamp nut 13.

The clamping surface 12a of the clamping member 12 opposed to the surface 3a which contacts the tapered section 11 is at an angle, relative to the surface 3a, the angle being such that the space formed between the opposed faces 12a and 3a have the same taper angle as the tapered section 11.

In order to ensure that the clamping surface 12a of the clamping member 12 of the clamping member and the tapered section 11 remain properly aligned, the clamp member 12 includes side walls 12c extending from either side of the clamping surface 12a towards the bracket 3 so that the clamping member 12 has a substantially “U” shape in cross section. The elongate member 10 has flat parallel sides, at least in the central tapered section 11, and the separation of the side walls 12c of the clamping member 12 is arranged to be slightly greater than the spacing of the parallel sides of the elongate member 10 so that contact between the sides of the elongate member 10 and the side walls 12c of the clamping member 12 will locate and maintain the clamping member 12 in proper alignment with the elongate member 10.

In the illustrated embodiment the whole length of the elongate member 10 has a uniform taper. This is preferred for ease of manufacture but is not essential. In the embodiment the range of movement of the elongate member 10 relative to the clamping member 12 is limited by the length of the slot 11a and accordingly only the taper of the central section 11 able to contact the clamping member 12 is important.

The bracket 3 comprises a flat attachment section 3a and an arm section 3b connected by a pair of opposite handed right angle bends 3c and 3d. This construction of the bracket 3 is preferred to match the shape of the bracket 3 to the “I” beam or girder profile of the fixed structure 4, as shown in FIG. 5. The flat attachment section 3a of the bracket 3 is provided with a number bolt holes 3e allowing the bracket 3 to be bolted to the fixed structure 4. The arm section 3b of the bracket 3 is shaped to locate the cable securing section 5 of the bottom anchor assembly 1 in a desired position relative to the fixed structure 4 as required by the geometry of the fall arrest system as a whole.

The profile of the bracket 3 can be varied as necessary to match the profile of different fixed structures as required in different applications.

In use, the bracket 3 is secured to the fixed structure 4 by bolts passing through the bolt holes 3e. The safety line 2 is passed through the tube 8 and then secured within the cable securing section 5 by tightening the securing bolt 9 onto the safety line 2.

In the preferred embodiment of the invention the bolt holes 3e are spaced to allow the bracket 3 to be bolted to step bolt attachment holes, which are commonly provided on pylons and communication masts.

Then, a tension applying and measuring apparatus is attached to the elongate member 10 by passing a hooked engagement end of the tensioning apparatus through the engagement aperture 14 of the elongate member 10. Tension is then applied to the safety line 2 through the bottom anchor assembly 1 using the tension applying and measuring apparatus until this apparatus indicates that the tension in the safety line 2 has reached a required value.

When the safety line 2 is at the required tension, the clamp nut 13 is tightened to urge the bracket 3 and the clamp member 12 together and so clamp the tapered section 11 of the elongate member 10 between them.

The tension applying and measuring apparatus can then be removed and the applied tension on the safety line 2 will be maintained at the required value by the bottom anchor assembly 1.

The tapered section 11 and the matching tapered receiving opening defined between the clamping surface 12a of the clamping member 12 and the surface 3a of the bracket 3 form a wedge clamp arrangement. This wedge clamp provides very positive clamping of the elongate member 10 and prevents any significant slippage or relative movement of the relatively angled surfaces of the clamping member 12 and the bracket 3. This provides very positive location of the elongate member 10 relative to the bracket 3 and ensures that the desired tension is reliably maintained in the safety line 2.

As a result, the risk of an unpredictable reduction in the tension on the safety line 2 due to slippage of the clamp is avoided. As is well known, in order for reliable and safe operation of height safety equipment using a tensioned safety line, it is essential that the tension on the safety line maintained at the intended value.

1. An anchor assembly for an elongate safety line, the anchor assembly comprising safety line gripping means bracket means and a releasable clamping means connecting the gripping means and the bracket means, in which the releasable clamping means comprises a tapered clamp formed by first and second opposed clamping surfaces defining a tapered space between them, a tapered member having a tapered profile matching the tapered space and a clamping element adapted to urge the first and second clamping surfaces together to clamp the tapered member between them.

2. An anchor assembly according to claim 1, in which the gripping means is connected to the tapered member and the bracket means is connected to the first and second opposed clamping surfaces.

3. An anchor assembly according to claim 2, in which the gripping means and the tapered member are spaced apart and are linked by a connector arm means.

4. An anchor assembly according to claim 3, in which the safety line gripping means and the connector arm means are arranged to allow a safety line traveller moving along a safety line gripped by the safety line gripping means to pass over the safety line gripping means and the connector arm means.

5. An anchor assembly according to claim 1, in which the clamping element is a nut engaging a threaded shaft extending from the first clamping surface and passing through an aperture in the second clamping surface.

6. An anchor assembly according to claim 5, in which the threaded shaft passes through a slot in the tapered member.

7. An anchor assembly according to claim 5, and further comprising a pair of spaced apart parallel sidewalls extending outwardly from and on either side of the first clamping surface to define a “U” shaped channel, the tapered member being located within the channel.

8. An anchor assembly according to claim 1, in which the safety line gripping means comprises a tube through which the safety line passes.

9. An anchor assembly according to claim 1, in which the tapered member includes an engagement aperture allowing a tension load to be applied to the tapered member.

10. An anchor assembly according to claim 1, in which the anchor assembly is a bottom anchor assembly for a substantially vertically oriented safety line.

11. (canceled)
